(19) United States
(12) Patent Application Publication
(10) Pub. No.: US 2024/0419487 A1
(43) Pub. Date: Dec. 19, 2024

(54) PROACTIVE EXECUTION SYSTEM

(71) Applicant: Microsoft Technology Licensing, LLC, Redmond, WA (US)

(72) Inventors: Srinagesh SHARMA, LONG ISLAND CITY, NY (US); Christopher Quirk, Seattle, WA (US); Adam Douglas TROY, Bothell, WA (US); Aditya VASAL, Redmond, WA (US); Kuleen Haresh MEHTA, Sammamish, WA (US); Aleksandr MILANIN, Bellevue, WA (US); Deepak MISHRA, Bothell, WA (US); Kelvin Kawai TAM, Bellevue, WA (US)

(21) Appl. No.: 18/334,768

(22) Filed: Jun. 14, 2023

(51) Int. Cl. G06F 9/48; H04L 51/18

(52) U.S. Cl. CPC G06F 9/4881; H04L 51/18

(57) ABSTRACT

A proactive execution system receives messages or other information from a plurality of different information channels. The proactive execution system automatically identifies messages that include a request for a user to perform a task. The proactive execution system then automatically generates a plan for executing that task and calls a plan execution system, with the plan, to perform the task. The proactive execution system receives a result from the plan execution system and generates an output indicative of that result, for access by the user.

### BACKGROUND

There are many types of artificial intelligence (AI) models that perform a wide variety of different types of tasks. The type of AI model is often defined by the function that the model performs. For instance, natural language processing AI models perform tasks related to natural language processing. Robotics AI models perform tasks related to robotics. Autonomous vehicle AI models perform tasks related to autonomously controlling vehicles. Vision processing AI models perform tasks related to vision and image processing. These are just a few examples of the different types of AI models that are currently being used to perform tasks.

One specific type of AI model is referred to as a large language model (LLM). An LLM is a language model that includes a large number of parameters (often in the tens of billions or hundreds of billions). An LLM is often referred to as a generative AI model in that it receives, as an input, a prompt which may include data, and an instruction to generate a particular output. For instance, for such models a generative AI model may be asked to summarize the contents of an article where the instruction to generate a summary, and the contents of the article, are input to the model as a prompt. The response generated by the model is a generative output in the form of a summary.

Other types of AI models perform classification. For instance, for such models a prompt may be generated which inputs data that is to be classified into one of a plurality of different categories. The AI model generates an output identifying the classification for the input.

The discussion above is merely provided for general background information and is not intended to be used as an aid in determining the scope of the claimed subject matter.

### SUMMARY

A proactive execution system receives messages or other information from a plurality of different information channels. The proactive execution system automatically identifies messages that include a request for a user to perform a task. The proactive execution system then automatically generates a plan for executing that task and calls a plan execution system, with the plan, to perform the task. The proactive execution system receives a result from the plan execution system and generates an output indicative of that result, for access by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A and 1B (collectively referred to as FIG. 1) show a block diagram of one example of a computing system architecture.

FIG. 2 is a flow diagram illustrating one example of the operation of a proactive execution system in proactively performing tasks for a user.

FIG. 3 is a flow diagram illustrating one example of the operation of the proactive execution system, in more detail, in which a plurality of chained prompts are generated and submitted to a set of artificial intelligence (AI) models in order to generate the plan which will be executed by a plan execution system.

FIG. 4 is a flow diagram illustrating one example of the operation of the proactive execution system, in more detail, in generating a single prompt that can be submitted to a set of AI models to obtain the plan that will be executed by a plan execution system.

FIG. 5 is a block diagram showing one example of the computing system architecture illustrated in FIG. 1, deployed in a remote server architecture.

FIGS. 6-8 show examples of mobile devices that can be used by a user.

FIG. 9 is a block diagram showing one example of a computing environment that can be used in the architectures and systems described with respect to previous figures.

### DETAILED DESCRIPTION

As discussed above, there are many different types of artificial intelligence (AI) models that can be used to perform tasks. However, these tasks are often triggered by user interaction. For instance, when a user receives an email that requests the user to perform a task, the user may invoke a generative AI model by requesting the AI model to “Reply to this email as me.” Similarly, when an email requests the user to perform a task, such as create a document, create a slide presentation, etc., then the user may invoke an AI model with a prompt that requests the AI model to: “Generate a document about this particular subject”, “Generate a slide presentation about this particular subject”, etc.

Because the AI models are invoked by user interactions, the AI models attempt to perform the requested tasks with relatively low latency, so that the user need not wait too long to receive the response from the AI model. In attempting to perform the tasks in relatively low latency, the AI model often consumes a relatively large amount of computing system resources, memory, and power.

Therefore, the present description describes a system that automatically processes messages received by a user through a plurality of different communication channels. The proactive execution system automatically identifies messages that are asking the user to perform a task (both implicit requests and explicit requests) and then automatically generates a plan to perform that task (e.g., through prompt chaining, chain-of-thought prompting, etc.) to map the request in the message to a set of functions that can be performed by one or more task execution systems. The functions are referred to herein as a task execution plan. The proactive execution system can automatically submit the task execution plan to the task execution system to have the task executed. For instance, the task may be to draft a responsive email, to write or revise a document, to generate a slide presentation, or any of a wide variety of other tasks. Once the task is executed by the task execution system, the result of the task execution (the execution result) is provided back to the user. For instance, where the task is to draft a responsive email, then the result of the executed task may be a draft email that is provided to the user for editing or sending, etc. Where the task is to draft a slide presentation or a document, the result of the task execution may be a draft document, a draft slide presentation, etc., which can be provided to the user for further editing, for sending to a particular recipient, etc.

This proactive system provides a significant technical advantage over current systems. Because the present, proactive system does not wait for user interaction, but instead proactively identifies and performs the identified tasks, the present system can perform those tasks over a much longer latency and can thus perform much more complex tasks that require significantly larger amount of reasoning and iteration to complete the task. This also means that the present, proactive system can perform the tasks using less power, less computing system resources, less memory, etc. Even where the same amount of computing system resources, memory, and power are consumed, that consumption can be spread out over a longer time, or the computation can be done when the system is less busy, to spread the load more evenly over time, so that the system performance is not degraded.

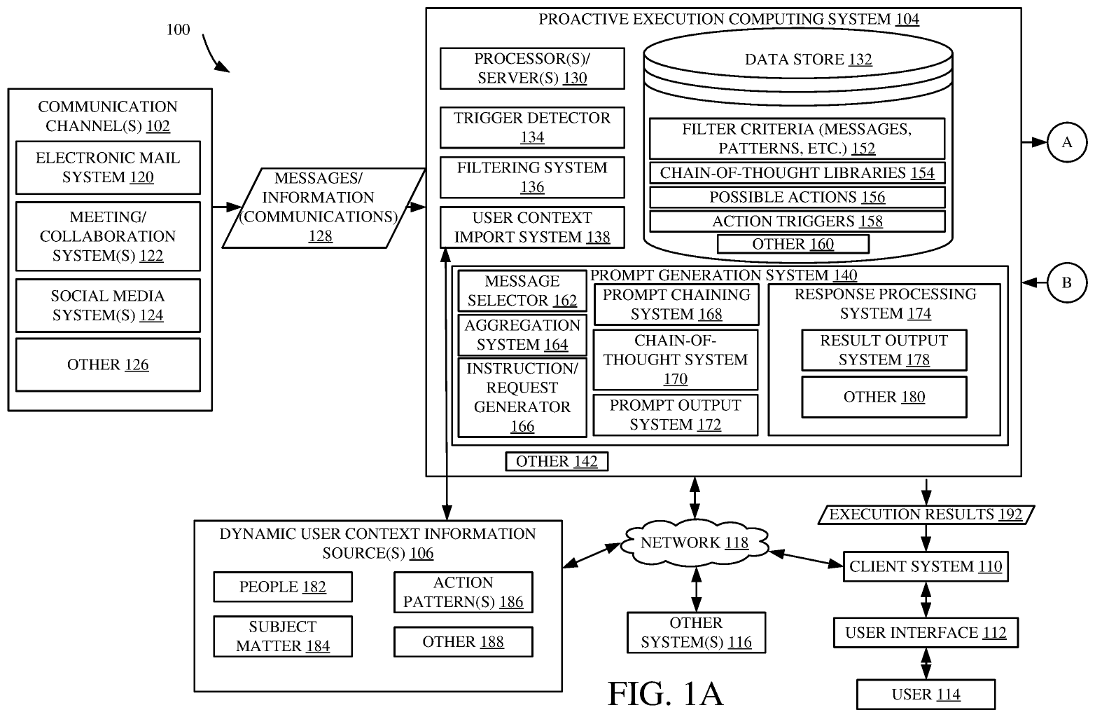

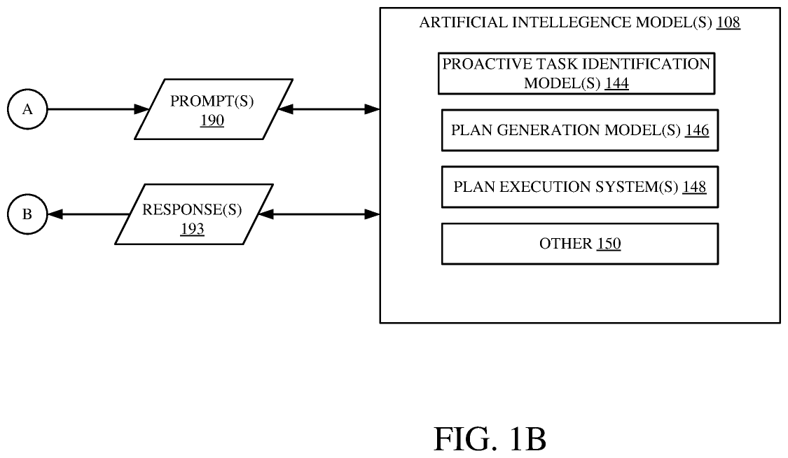

FIGS. 1A and 1B (collectively referred to herein as FIG. 1) show a block diagram of one example of a computing system architecture 100 in which a plurality of different communication channels 102 are accessible by a proactive execution computing system 104. System 104 also has access to dynamic user context information sources 106 and a plurality of artificial intelligence models 108. FIG. 1 also shows that a client system 110 generates a user interface 112 for interaction by a user 114. User 114 can interact with user interface 112 in order to control and manipulate client system 110, proactive execution computing system 104, and any of a wide variety of other computing systems 116. The systems and sources and channels in FIG. 1 can be connected to one another directly or over one or more networks 118. Networks 118 can include a wide area network, local area network, Wi-Fi, near field communication network, cellular communication network, or any of a wide variety of other networks or combinations of networks. Before providing a more detailed description of the operation of architecture 100, a description of some of the items in architecture 100, and their operation, will first be provided.

Communication channels 102 can include an electronic mail (email) system 120, one or more meeting or collaboration systems 122, social media systems 124, and/or any of a wide variety of other systems 126. The communication channels 102 provide communications (communications) 128 to proactive execution computing system 104. The communications 128 may, for instance, be email messages from email system 120, meeting transcripts or team messages from meeting/collaboration systems 122, social media messages, posts, etc. from one or more social media systems 124, among other communication. Proactive execution computing system 104 includes one or more processors or servers 130, data store 132, trigger detector 134, filtering system 136, user context import system 138, prompt generation system 140, and other items 142. Artificial intelligence (AI) models 108 can include proactive task identification models 144, one or more plan generation models 146, and one or more plan execution systems 148, as well as other items 150. The AI models can be generative AI models such as LLMs or other models. Data store 132 can include filter criteria 152, chain-of-thought libraries 154, possible actions 156, action triggers 158, and other items 160. Prompt generation system 140 can include message selector 162, aggregation system 164, instruction/request generator 166, prompt chaining system 168, chain-of-thought system 170, prompt output system 172, response processing system 174, and any of a wide variety of other prompt generation functionality 176. Response processing system 174 can include result output system 178 and other items 180.

Trigger detector 134 detects when proactive execution computing system should process communications 128 to identify tasks that are being requested of user 114 and proactively execute those tasks or part of those tasks. The trigger criteria may be, for instance, when the number of new communications 128 has reached a threshold level, the amount of time that has been passed since communications 128 have been processed, or the trigger criteria may indicate that processing should be substantially continuous so that every time one or more new communications 128 are received, they are processed.

Once processing is triggered, filtering system 136 applies filter criteria to filter the communications 128 to filter out communications 128 for which no further proactive execution processing is to be performed. Filtering system 136 may identify promotional emails, social media posts, or other communications 128 for which no further processing needs to be performed. Filtering system 136 generates an output indicative of a filtered set of communications 128 for further processing. Filtering system 136 can access filter criteria 152 which can be a static set of filter criteria, a dynamically changing set of filter criteria, etc.

Prompt generation system 140 receives the filtered set of communications and can process them individually, or in sets. Message selector 162 selects a communication or a set of communications for processing. Aggregation system 164 can aggregate additional data corresponding to the communication or set of communications that will be processed as well. For instance, where the selected message is an email communication, then aggregation system 164 may aggregate the contents of the thread to which the selected email message belongs. Aggregation system 164 can also use user context import system 138 to import user context information from sources 106. Information sources 106 can be sources of people 182 that are collaborators of user 114 and/or that are related to user 114 or that are related to the selected communication or set of communications. The context information can include subject matter information 184, such as the subject matter of the projects that user 114 is working on, the subject of documents or slide presentations authored by user 114 or on which user 114 has collaborated, the subject matter of other electronic mail messages or other messages generated or received by user 114, etc. The information sources 106 can include action patterns 186 which identify how user 114 has acted in the past. Such action patterns 186 may identify, for instance, that user 114 always quickly responds to email messages sent from the user's supervisor. The action patterns may indicate that user 114 often generates “Reply all” messages to the user's team or other collaborators identified by people information 182. The dynamic user context information sources 106 can include a wide variety of other sources 188 as well.

Instruction/request generator 166 in prompt generation system 140 then generates instructions or a request for a prompt. Prompt chaining system 168 and chain-of-thought system 170 can incorporate instructions, into the prompt, to perform prompt chaining or chain-of-thought processing. Examples of this are described below. Prompt output system 172 includes the content of the selected communications, any aggregated information (such as user context information) aggregated by system 164, as well as the instructions or requests and other information (such as possible actions 156 that can be identified by the AI models 108 in response to the prompt, action triggers 158 that will trigger those actions, information based on chain-of-thought libraries 154, examples, of a requested generation or other information that may be incorporated into the prompt that is provided to AI models 108.

Prompt output system 172 outputs one or more prompts 190 to AI models 108. In response, proactive task identification model(s) 144 identify whether any tasks are being requested of user 114 in the selected communication or set of communications and any deadlines or timelines for completing the task. It will be noted that tasks may be either implicitly requested or explicitly and the proactive task identification model(s) 144 identify both types. For example, an implicit request may be a communication which states “I do not have sufficient documentation to approve this expense.” The implicit request is to provide more documentation. An explicit request may be a communication that explicitly assigns a task to the user, such as “[User], please generate a slide presentation showing [Y].” If one or more tasks are being requested of user 114, then plan generation model(s) 146 generate an output indicative of a plan that can be executed by plan execution system(s) 148 in order to perform the identified task. For instance, plan generation model(s) 146 may map an identified task to a set of functions that are performed in order to execute that task. The set of functions may include corresponding triggers that can be used to invoke and execute the functions. The functions and triggers may form a task execution plan which is provided to plan execution system(s) 148 for execution. Plan execution system(s) 148 may provide, as a response 193, the execution results. In one example, prompt generation system 140 may use prompt chaining and chain-of-thought processing to generate multiple prompts to identify a task, generate a plan, and execute the plan. In another example, system 140 generates a single, more complex, prompt to obtain the execution results. Other numbers of prompts can be used as well.

In one example, the task execution plans can be executed in an order based upon the deadline or timeline for completing the task. Tasks with earlier deadlines or shorter timelines can be executed and returned to user 114 first. The tasks can be executed in other orders as well. For instance, when tasks are identified, the tasks can also be classified into an importance category by models 144. The higher importance tasks may be executed before lower importance tasks, even through the lower importance tasks have a shorter deadline. These are only examples of how the task execution can be ordered.

Response processing system 174 may receive responses 193 from model(s) 144 and/or 146 and perform prompt chaining operations in which a next prompt is generated with the result of the previous response 193. Response processing system 174 can also use result output system 178 to output the results of plan execution system 148 as execution results 192. Execution results 192 can be surfaced by client system 110 on a user interface 112 for interaction by user 114. For instance, execution results 192 may be a draft email, a draft document, a draft slide presentation, or any of a wide variety of other execution results that are output by plan execution system 148 in executing the plan generated by plan generation models 146.

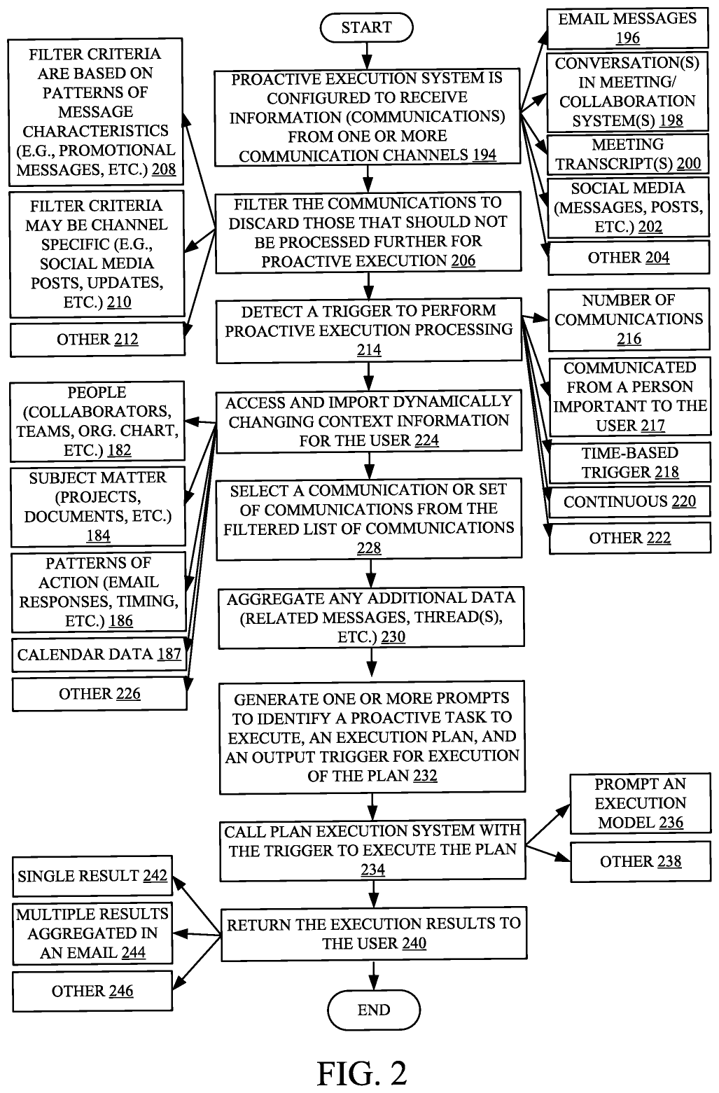

FIG. 2 is a flow diagram illustrating one example of the operation of proactive execution computing system 104 in more detail. It is first assumed that proactive execution computing system 104 is configured to receive the communications 128 from one or more communication channels 102, as indicated by block 194 in the flow diagram of FIG. 2. The communications can include email messages 196, conversations 198 that may be generated in meeting or collaboration systems 122, meeting transcripts 200 that may also be generated from meeting systems 122, social media messages or posts 202 that may be generated by social media systems 124, and/or a wide variety of other communications the communications 204. In one example, communications 128 are filtered by filtering system 136 to generate a filtered list of communications which may be stored until trigger detector 134 detects a trigger for proactive execution processing system 104 to perform processing on the stored, filtered list of communications. Filtering the communications to discard those that should not be processed further for proactive execution, is indicated by block 206 in the flow diagram of FIG. 2. The filtering system 136 may obtain filter criteria 152 from data store 132 or elsewhere. In one example, the filter criteria 152 are based on the patterns of message characteristics which may be compared to known message characteristic patterns to identify the communications as those which should be excluded from further processing. For instance, where the pattern of message characteristics tend to indicate that the communication is a promotional message or another type of message that need not be processed, the message may be discarded by filtering system 136. Filtering the communications based upon patterns of message characteristics is indicated by block 208 in the flow diagram of FIG. 2. The filter criteria can be channel-specific filter criteria 210. For instance, where the communications 128 are from social media system 124, then social media posts or social media updates, or other similar information generated by social media systems 124 may be filtered out by filtering system 136 so only the social media messages are processed. The filter criteria can be any of a wide variety of other filter criteria 212 as well.

At some point, trigger detector 134 detects a trigger to perform proactive execution processing, as indicated by block 214 in the flow diagram of FIG. 2. For instance, the trigger may be detected when the number of communications 128 reach a threshold, as indicated by block 216. The trigger may be detected when a communication is received from a person important to the user, as indicated at block 217. The trigger may be a time-based trigger indicating that, after a certain amount of time has elapsed, system 104 performs proactive execution processing. Detecting a time-based trigger is indicated by block 218 in the flow diagram of FIG. 2. The trigger may be substantially continuously detected, as indicated by block 220, every time a new communications 128 is received. The trigger can be detected in other ways as well, as indicated by block 222.

When proactive execution computing system 104 is to perform proactive execution processing for a communication 128 received by a user 114, then user context import system 138 accesses dynamic user context information sources 106 to identify any user context information that should be imported in order to perform the proactive execution processing. It will be noted that the information in data sources 106 may be dynamically changing so that the user context information is the most up-to-date information corresponding to user 114. Accessing and importing the dynamically changing user context information for user 114 is indicated by block 224 in the flow diagram of FIG. 2. The context information can be people information 182 such as collaborators, team members, people identified close to user 114 on an organization chart or profile information, or other people information 182. The user context information can include subject matter information 184 which may be identified based upon the subject matter of projects that user 114 is working on, documents (e.g., word processing documents, slide presentation documents, etc.) generated by user 114, the subject matter of messages or email messages generated or received by user 114, etc. The user context information can include action pattern information 186 which identifies how quickly, how often, etc., that user 114 performs actions, such as sending email responses, drafting original emails, performing document editing operations, etc. The user context information can also include any of a wide variety of other information as well, as indicated by block 226 in the flow diagram of FIG. 2.

Message selector 162 then selects a communication, or a set of communications from the filtered list of communications, as indicated by block 228. For example, the messages can be selected chronologically, in the order in which they were received. The messages may be preferentially selected based on importance (e.g., urgent messages may be selected first, etc.). The messages may be selected in other ways as well. Aggregation system 164 can aggregate any additional data such as related message threads, meeting minutes, transcripts, etc., corresponding to the selected communication, as indicated by block 230. In one example, aggregation system 164 can access an AI model or another relevancy model to identify relevant data which is to be aggregated. In another example, system 164 can perform keyword searching through the user's messages, documents, etc. to identify data that should be aggregated. The aggregated data is then provided to instruction/request generator 166.

Instruction/request generator 166, prompt chaining system 168, and chain-of-thought system 170 then generate one or more prompts that are output by prompt output system 172 to AI models 108 to identify a proactive task that should be executed based upon the content of the selected communication, to generate an action plan (or a set of functions) for executing the task, and generate an output trigger indicative of how to trigger each of the functions in the execution plan. The prompts can, themselves, be generated by an AI model or the prompts can be generated by a rules driven system and/or by invoking a pre-designated prompt or set of prompts. A single prompt can be generated to both request the identity of tasks and the plan to execute those tasks, or a sequence of prompts can be used to sequentially request that the proactive task be identified and then the task execution plan be generated, and then the triggers be identified. Generating the prompts to identify the proactive task, and the task execution plan, and also obtaining triggers for each function in the task execution plan is indicated by block 232 in the flow diagram of FIG. 2.

Prompt generation system 140 then invokes (e.g., calls or prompts) plan execution system(s) 148 with the triggers in the task execution plan in order to execute the task. Invoking the plan execution system(s) 148 is indicated by block 234 in the flow diagram of FIG. 2. In one example, for instance, prompt generation system 140 receives the task execution plan and the corresponding triggers from plan generation models 146 and generates an additional prompt to a generative AI model in plan execution system 148 to execute the plan. Prompting a generative AI model is indicated by block 236 in the flow diagram of FIG. 2. Invoking the plan execution system(s) 148 can be done in other ways as well, as indicated by block 238.

Plan execution system(s) 148 then return the execution results to result output system 178 in response processing system 174. The execution results are then output as execution results 192 to client system 110 where they can be surfaced for user 114 in a user interface 112. Returning the execution results 192 to user 114 is indicated by block 240 in the flow diagram of FIG. 2. The results can include a single result 242 or multiple results that are provided in an email or in another way, as indicated by block 244. The execution results can be returned to user 114 in other ways as well, as indicated by block 246 in the flow diagram of FIG. 2. User 114 can then act on the execution results 192, such as by editing them, sending them to a recipient, etc.

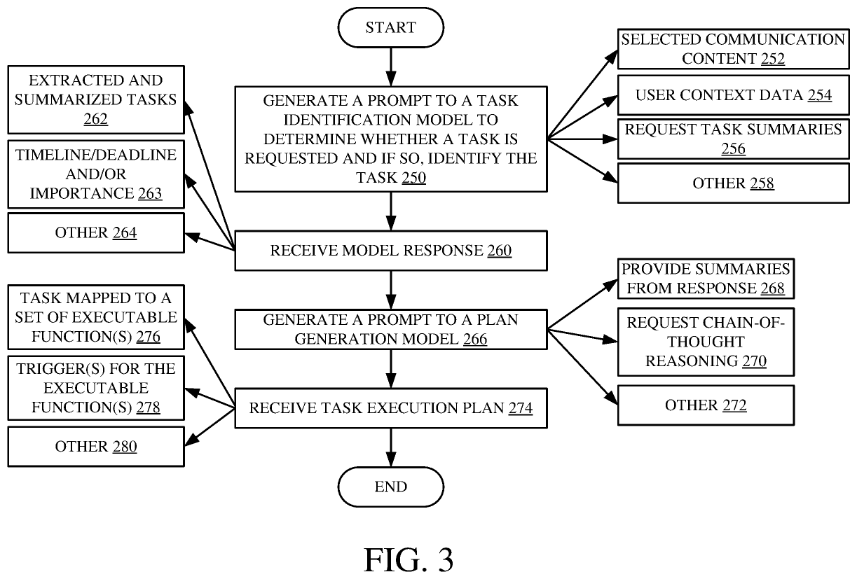

FIG. 3 is a flow diagram showing one example of the operation of prompt generation system 140, in more detail. In the example shown in FIG. 3, prompt chaining system 168 generates multiple prompts to one or more different AI models 108 in order to obtain the plan for executing the identified task. Table 1 shows one example of such a prompt which prompts the AI model to summarize user activities.

TABLE 1
USER ACTIVITY PROMPT:
Summarize this for {User}\'s activities.
{PromptInstructions}
Sarah: Hello {User},
This is a friendly reminder that temporary badge 000 was issued to you
on today Aug. 20, 2019. Please return the badge to the main desk
before leaving the office for the day to avoid it being deactivated.
If no one is present at the desk, please leave the badge in the return box.
Thanks,
Sarah
Answer: You need to return the badge to the main desk before leaving
the office for the day.
Leon: ABC Hack Code: Groups Chat Digest. Mia could you link the
Research team to the code used for the ABC showcase?
Answer: None
{User} to Carlos: Urgent ACTION Needed for Grombit Partners.
Completed.
Answer: None
{User} to Anna and Others: I have added you and Greg to the
Labaobao Github Repo. Let me know if you can access it.
Answer: None.
Isaac: The deadline for the proposal is tomorrow Sept 28^{th}. I would love
to see drafts on BLAMBAY proposals for Flarble Monitoring.
Answer: Isaac would love to see one-pagers for Flarble Monitoring.
{ParsedComms}
Answer:

It is assumed that message selector 162 has selected a communication and that aggregation 164 has aggregated any user context data from sources 106 or elsewhere. Instruction/request generator 166 then generates instructions or a request to the AI model 108 which can be used by prompt chaining system 168 to generate a first prompt prompting proactive task identification model 144 to process the selected communication and the aggregated data (e.g., user context data, etc.) to identify whether the user 114 is being asked to perform a task in the selected communication and, if so, to identify that task. Generating a prompt to the proactive task identification model 144 to determine whether a task is being requested and, if so, to identify that task (as well as the timeline or deadline for the task and the importance of the task), is indicated by block 250 in the flow diagram of FIG. 3.

It can be seen from Table 1 that the prompt includes the content of the selected message, as indicated by block 252, as well as dynamic user context data (such as the collaborators of user 114) as indicated by block 254. In the example in Table 1, the instruction/request generator 166 has also requested that the identified task be summarized in the model response, as indicated by block 256. The prompt can include a wide variety of other information as well, as indicated by block 258.

Response processing system 174 then receives the response 193 from proactive task identification model 154. Receiving the response 193 is indicated by block 260 in the flow diagram of FIG. 3. In the example illustrated in Table 1, the response includes any tasks that have been requested of user 114 identified in the selected communication, and summaries for those tasks, as indicated by block 262. The response may also include the timeline or deadline for performing the task and/or the importance of the task, as indicated by block 263. The response 193 can include any of a wide variety of other information as well, as indicated by block 264.

Response processing system 174, discussed with respect to FIG. 3, then provides that response back to prompt chaining system 168 where the response can be used in generating another prompt to plan generation model 146. Table 2 shows one example of such a prompt.

TABLE 2
Infer the action from the request.
{PromptInstructions}
Request: The deadline for proposals is tomorrow Sept 28th. Isaac would
love to see one-pagers BLAMBAY proposals for Flarble Monitoring.
Answer: Let′s think step by step
{REASONING_EXAMPLE_1}
Therefore, the answer is Action1 (type=′BLAMBAY Proposal′,
topic=′Flarble Monitoring′).
Request: Sandra needs your help with debugging the KORMA
algorithm for the RIVET project.
Answer: Let′s think step by step.
{REASONING_EXAMPLE_2}
Therefore, the answer is Action2(algorithm=′KORMA′,
project=′RIVET′, purpose=′debugging′).
Request: Bob wants to update the CAPTAIN slides with the latest
results from the BAZOOKA experiment.
Answer: Let′s think step by step.
{REASONING_EXAMPLE_3}
Therefore, the answer is Action3(name=′CAPTAIN′,
source=′BAZOOKA′, purpose=′update′).
Request: {Request}.
Answer: Let′s think step by step.

Generating a prompt to plan generation model 146 is indicated by block 266 in the flow diagram of FIG. 3. In one example, the prompt to the plan generation model 146 includes the task summary or summaries received in the response from proactive task identification model 144, as indicated by block 268 in the flow diagram of FIG. 3. The second prompt can include a prompt to perform chain-of-thought reasoning to generate the plan, as indicated by block 270, and the prompt can include a wide variety of other information, as indicated by block 272.

In one example, plan generation model 146 uses chain-of-thought processing and first order logic in order to map the identified task to a set of functions that are to be performed in order to execute the task. The plan generation model 146 also illustratively identifies the triggers for executing the mapped functions. Receiving a task execution plan from plan generation model(s) 146, as a response 193 is indicated by block 274 in the flow diagram of FIG. 3. Generating the task execution plan by mapping the task to a set of executable functions is indicated by block 276, and outputting, as part of the task execution plan, the triggers for the executable functions is indicated by block 278. In one example, model 146 includes or accesses a library of chains-of-thought which are provided as examples in the prompt so the AI model decomposes the problem into intermediate reasoning steps and generates the output to show those steps in the response, in order to arrive at the correct plan corresponding to the identified task. Generating and receiving the task execution plan can be done in a wide variety of other ways as well, as indicated by block 280.

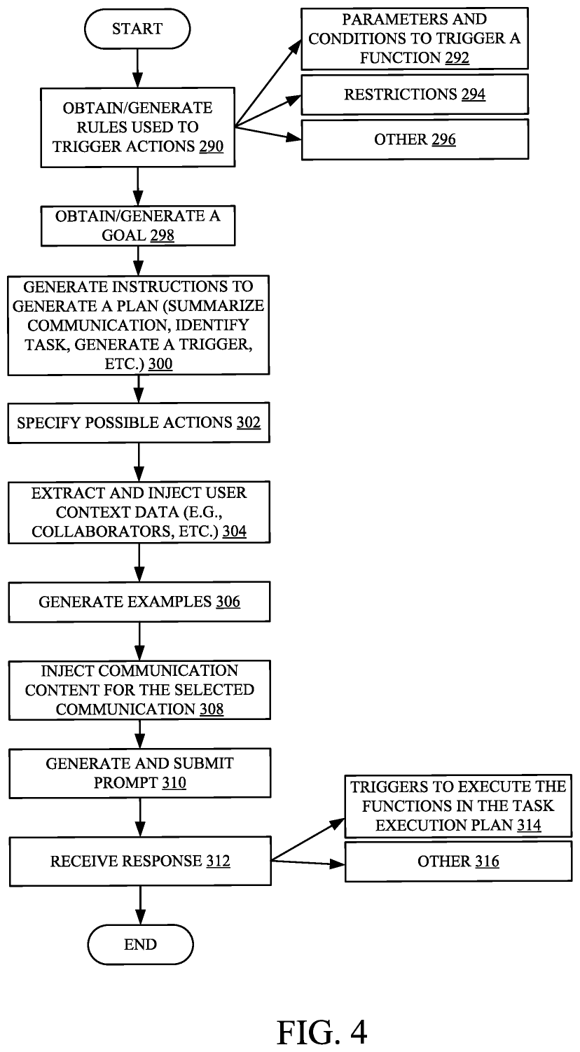

FIG. 4 is a flow diagram showing one example of the operation of prompt generation system 140, in more detail, in which a single, more extensive prompt is generated by prompt generation system 140, and submitted to AI models 108. One example of such a prompt is shown in Table 3.

TABLE 3
[SYSTEM_INSTRUCTIONS]
[PROACTIVE_ASSISTANCE_INSTRUCTIONS]
[EXAMPLE_USER_INFORMATION]
[EXAMPLE_GRAPH_INFORMATION]
{communcation_preface}
Isaac: The deadline for the proposal is tomorrow Sept 28th. I would love
to see drafts on BLAMBAY proposals for Flarble Monitoring.
{REASONING_EXAMPLE_1}
Assistant: Action1(type=′BLAMBAY Proposal′, topic=′Flarble
Monitoring′).
PROACTIVE_ASSISTANCE_EXAMPLE_1
{communication_preface}
Sarah: Hello Joshua,
This is a friendly reminder that temporary badge 000 was issued to you
on today. Please return the badge to the main desk before leaving the
office for the day to avoid it being deactivated. If no one is
present at the desk, please leave the badge in the return box.
Thanks, Sarah
{REASONING_EXAMPLE_2}
Assistant: None
PROACTIVE_ASSISTANCE_EXAMPLE_2
{communication_preface}
Hannah Smith: Hey, can you help with prepping the KORMA
Presentation for RIVET? I′ve placed it in the common folder.
REASONING EXAMPLE_3}
Assistant: Action2(topic=′KORMA′, project=′RIVET′,
length=unknown)
PROACTIVE_ASSISTANCE_EXAMPLE_3
[USER_INFORMATION]
[GRAPH_INFORMATION]
{communication_preface}
(Message}
Assistant:

The single prompt is configured so that the response 193 to the prompt is the action plan (or set of functions) that is to be executed in order to perform an identified task, along with the function triggers that can be used to trigger those functions in plan execution system(s) 148. Therefore, in response to the single prompt, AI models 108 not only determine whether a task is being requested of user 114 and identify that task, but also map the task to a set of functions to generate the task execution plan, and includes the triggers that can be used by plan execution system 148 to execute those functions. Then, response processing system 174 simply needs to provide the plan and triggers to plan execution system 148 which will generate the execution results 192.

It can be seen in Table 3 that instruction/request generator obtains or generates the rules that are used to trigger different actions, as indicated by block 290, in the flow diagram of FIG. 4. The rules can include parameters and conditions that are needed in order to trigger a function in plan execution system 148, as indicated by block 292. The rules can also include restrictions which restrict when certain functions are triggered, as indicated by block 294. The rules used to trigger certain actions can include a wide variety of other information as well, as indicated by block 296. Instruction/request generator 166 then obtains or generates a goal which can be articulated in the prompt, as indicated by block 298. Generator 166 then also generates instructions to prompt AI models 108 to generate a task execution plan for any identified tasks, as indicated by block 300. For instance, the instructions may be to summarize a communication 128 that is being processed, to identify any tasks in that communication, and to generate triggers for functions that are to be executed in executing the identified task.

Instruction/request generator 166 can also specify some or all of the possible actions that can be identified. A list of those actions can be obtained from possible actions 156 in data store 132, or dynamically determined in other ways. Specifying the possible actions in the prompt is indicated by block 302.

Aggregation system 164 can then extract and inject user context data (such as collaborators, etc.) as indicated by block 304, and as also indicated by the example prompt shown in Table 3.

Generator 166 can also generate or otherwise access and inject examples into the prompt, as indicated by block 306. For instance, examples of certain types of tasks or activities can be stored in data store 132 or dynamically generated. Similarly, the examples can show chains-of-thought as well.

Message selector 162 injects the message content for the selected message, into the prompt, as indicated by block 308. Prompt output system 172 then generates the prompt based upon all the information and processing that has been performed, and submits that prompt 190 to AI models 108, as indicated by block 310 in the flow diagram of FIG. 4.

Model 144 determines whether the message content requests a task of user 114, and if so identifies that task, and submits the task to plan generation model 146. Plan generation model 146 then generates a task execution plan by mapping the task to functions that need to be executed in order to perform the task. Model 146 can also identify triggers that are used to execute the functions in the task execution plan. The response 193 is then provided back to response processing system 174.

Response processing system 174 can then submit the plan to plan execution system 148 to obtain execution results 192. Receiving a response 193 that includes the task execution plan and associated triggers is indicated by blocks 312 and 314 in the flow diagram of FIG. 4. The response can of course include a wide variety of other information as well, as indicated by block 316.

It can thus be seen that the present description describes a system which automatically and proactively processes communications received from a plurality of different communication channels in order to identify or predict tasks that a user will take in response to those communications. The system maps the task to executable functions in a task execution plan and automatically submits that task execution plan to a task execution system to obtain execution results. The execution results represent the results of the task which is to be executed by user 114. The execution results may be, for example, a draft email, a draft document, a draft slide presentation, or any of a wide variety of other execution results that can be submitted to user 114 for approval, editing, etc. It will be noted that, by automatically, it is meant that the action is performed without further user involvement except, perhaps, to authorize the action.

It will also be noted that the above discussion has described a variety of different systems, components, models, generators, and/or logic. It will be appreciated that such systems, components, models, generators, and/or logic can be comprised of hardware items (such as processors and associated memory, or other processing components, some of which are described below) that perform the functions associated with those systems, components, models, generators, and/or logic. In addition, the systems, components, models, generators, and/or logic can be comprised of software that is loaded into a memory and is subsequently executed by a processor or server, or other computing component, as described below. The systems, components, models, generators, and/or logic can also be comprised of different combinations of hardware, software, firmware, etc., some examples of which are described below. These are only some examples of different structures that can be used to form the systems, components, models, generators, and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

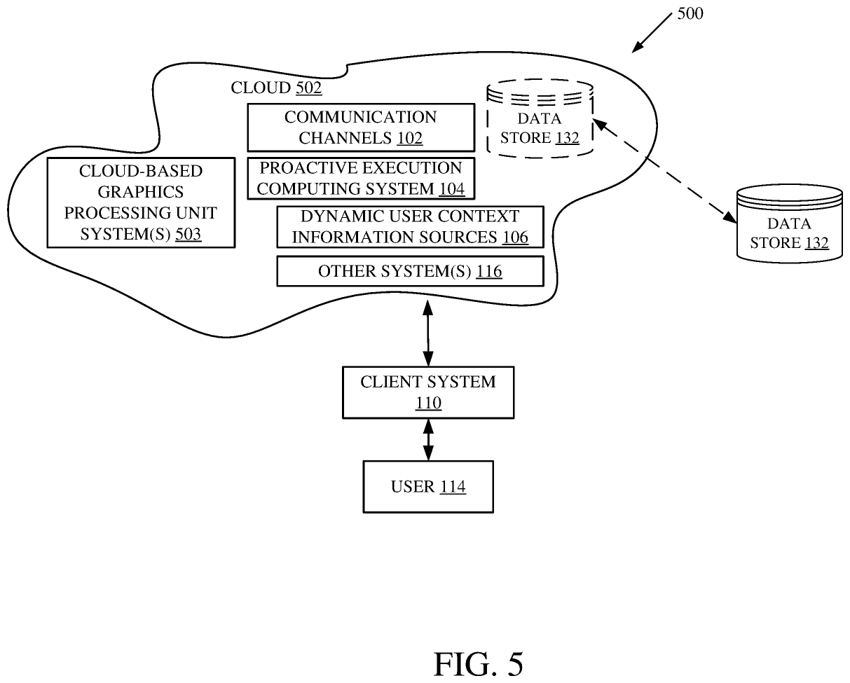

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, the components and functions can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that channels 120, systems 104, 116, sources 106, and data store 132 can be located in cloud 502 (which can be public, private, or a combination where portions are public while others are private). Therefore, user 114 uses a user device that has client system 110 to access those systems through cloud 502. Further, the processing can be performed using graphics processing units (GPUs) on client system 110, or GPU systems 503 disposed in cloud 502 or elsewhere. Other high performance computing systems can be used to perform the processing as well.

FIG. 5 also depicts another example of a cloud architecture. FIG. 5 shows that it is also contemplated that some elements of computing system architecture 100 can be disposed in cloud 502 while others are not. By way of example, data store 132 can be disposed outside of cloud 502, and accessed through cloud 502. Regardless of where the items are located, the items can be accessed directly by device 504, through a network (either a wide area network or a local area network), the items can be hosted at a remote site by a service, or the items can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

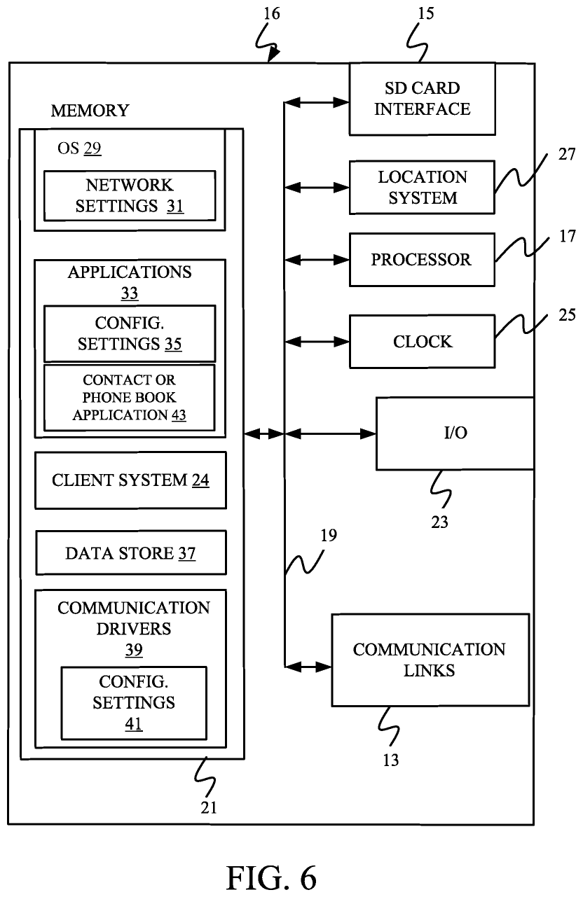

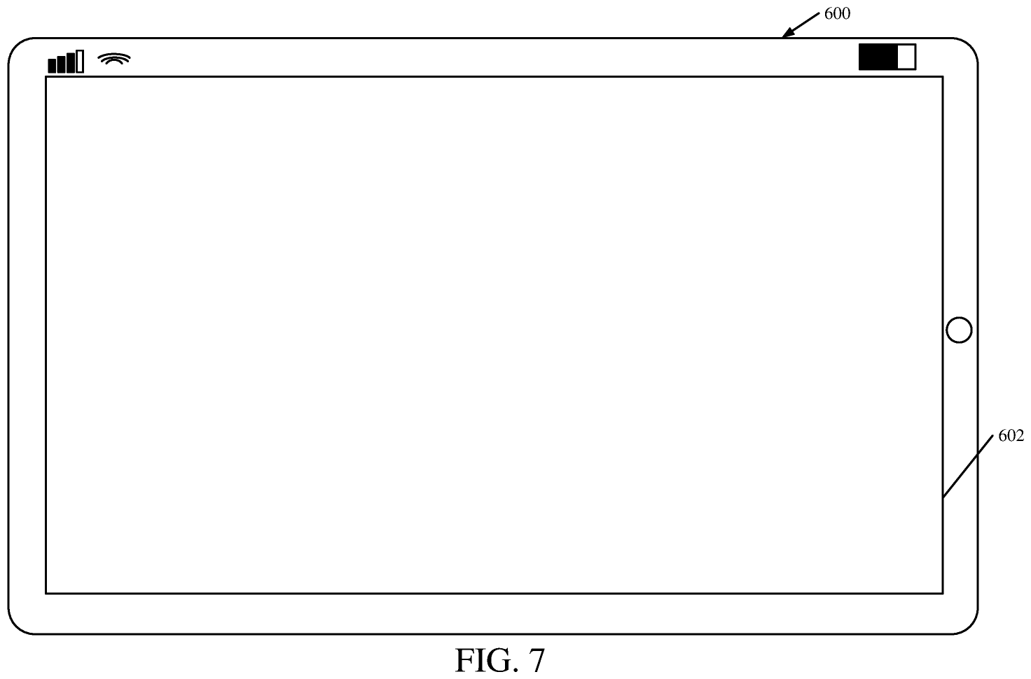

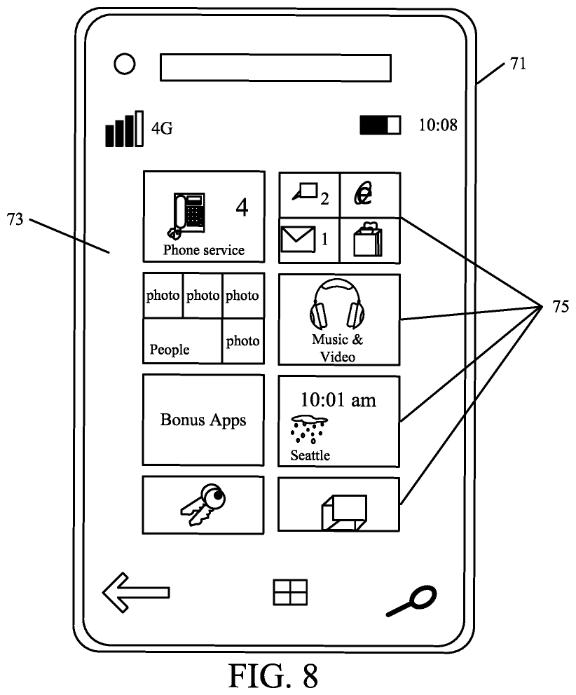

FIG. 6 is a simplified block diagram of one illustrative example of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of computing system architecture 100 or that interacts with architecture 100, or both. In the device 16, a communications link 13 is provided that allows the handheld device to communicate with other computing devices and in some examples provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. Clock 25 can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. System 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one example in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

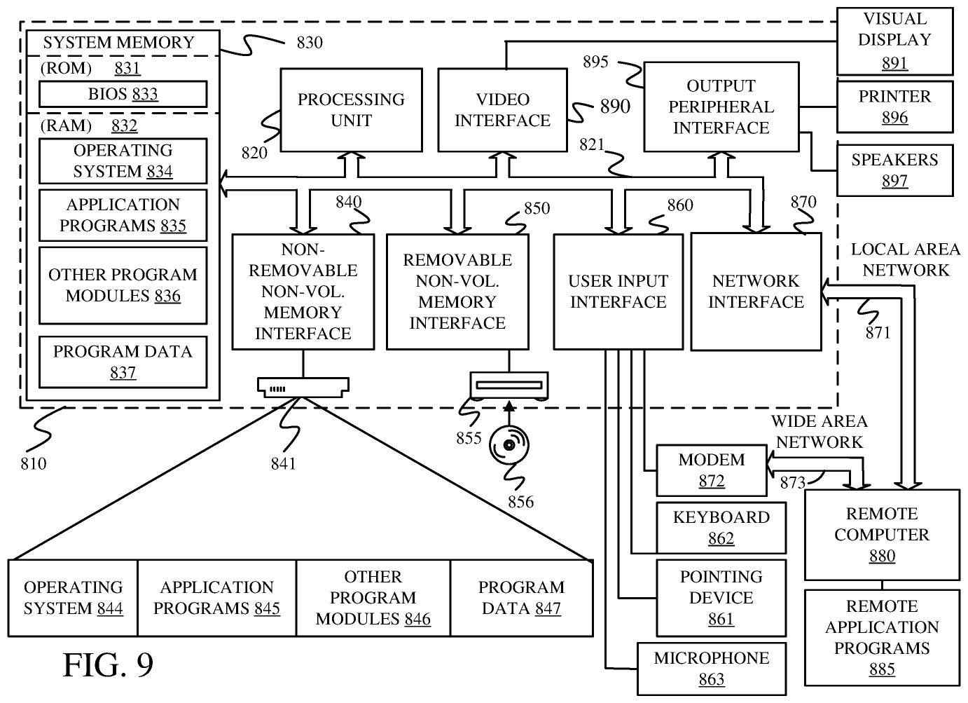

FIG. 9 is one example of a computing environment in which architecture 100, or parts of it, (for example) can be deployed. With reference to FIG. 9, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
automatically selecting a communication, from a plurality of different communications for a user;
automatically generating at least one prompt to a generative model based on the selected communication, the at least one prompt including user context information and requesting identification of a task in the selected communication, the at least one prompt further including a request to generate and execute a task execution plan to execute the identified task;
automatically sending the task execution plan to a plan execution system;
receiving an execution result from the plan execution system, the execution result being indicative of a result of executing the task execution plan; and
outputting the execution result for user interaction.

2. The computer implemented method of claim 1 wherein automatically generating at least one prompt comprises:
automatically generating a task identification prompt to prompt a task identification model to identify the task in the selected communication; and
receiving a response to the task identification prompt, the response identifying the task.

3. The computer implemented method of claim 2 wherein automatically generating at least one prompt further comprises:
automatically generating, based on receiving the response to the task identification prompt, a plan generation prompt to a plan generation model, the plan generation prompt including the identified task and requesting a task execution plan that is executable to perform the identified task; and
receiving a response to the plan generation prompt, the response to the plan generation prompt including the task execution plan, the task execution plan identifying executable functions that can be executed to perform the identified task.

4. The computer implemented method of claim 3 wherein automatically generating the task identification prompt includes generating a summarization request to summarize the identified task and wherein receiving a response to the task identification prompt comprises receiving a summary of the identified task.

5. The computer implemented method of claim 4 wherein automatically generating a plan generation prompt comprises:
generating the plan generation prompt to include the summary of the identified task.

6. The computer implemented method of claim 3 wherein receiving the response to the plan generation prompt includes:
receiving a function trigger corresponding to each of the executable functions identified in the task execution plan, each function trigger triggering, in a plan execution system, execution of a corresponding function.

7. The computer implemented method of claim 6 wherein receiving an execution result comprises:
sending the task execution plan to the plan execution system for execution of the functions triggered by the function triggers to generate the task execution result; and
receiving the execution result generated by executing the functions.

8. The computer implemented method of claim 7 wherein the plan execution system comprises a generative task execution model and wherein sending the task execution plan to the plan execution system further comprises:
automatically generating a task execution prompt to the generative task execution model, the task execution prompt including the function triggers.

9. The computer implemented method of claim 1 wherein automatically generating at least one prompt to a generative model comprises:
automatically generating a single prompt that prompts a set of generative models to identify the task in the selected communication and to generate the task execution plan based on the identified task, the task execution plan identifying a set of functions that can be executed to perform the identified task.

10. The computer implemented method of claim 9 wherein automatically generating the single prompt further comprises:
automatically generating the single prompt to prompt the plan execution system to execute the functions in the task execution plan and return the execution results.

11. The computer implemented method of claim 1 and further comprising:
receiving communications from a plurality of different communication channels; and
filtering the communications based on filter criteria to obtain a filtered set of communications for further processing and wherein selecting a communication comprises selecting the communication from the filtered set of communications.

12. A computer system, comprising:
at least one processor; and
memory that stores computer executable instructions which, when executed by the at least one processor, cause the at least one processor to perform steps, comprising:
automatically selecting a communication, from a plurality of different communications for a user;
automatically generating a prompt to a generative model based on the selected communication, the prompt including user context information;
receiving a response to the prompt from the generative model, the response being indicative of a task execution plan with a set of function triggers that trigger functions to execute to perform a task identified in the selected message;
automatically generating a task execution prompt for a generative task execution model, the task execution prompt including the set of function triggers;
receiving an execution result from the generative task execution model, the execution result being indicative of a result of executing the task; and
outputting the execution result for user interaction.

13. The computer system of claim 12 wherein automatically generating a prompt comprises:
automatically generating a task identification prompt to prompt a generative task identification model to identify the task in the selected communication; and
receiving a response to the task identification prompt, the response identifying the task and including a summary of the identified task.

14. The computer system of claim 13 wherein automatically generating a prompt to a generative model further comprises:
automatically generating, based on receiving the response to the task identification prompt, a plan generation prompt to a generative plan generation model, the plan generation prompt including the identified task and the summary of the identified task and a request portion requesting a task execution plan that is executable to perform the identified task; and
receiving a response to the plan generation prompt, the response to the plan generation prompt including the task execution plan, the task execution plan identifying executable functions that can be executed to perform the identified task.

15. The computer system of claim 12 wherein automatically generating a prompt to a generative model comprises:
automatically generating a single prompt that prompts a set of generative models to identify the task in the selected communication and to generate the task execution plan based on the identified task, the task execution plan identifying a set of functions that can be executed to perform the identified task.

16. The computer system of claim 15 wherein generating the single prompt further comprises:
automatically generating the single prompt to prompt the generative plan execution model to execute the functions in the task execution plan and return the execution results.

17. The computer system of claim 12 and further comprising:
receiving communications from a plurality of different communication channels; and
a filter configured to receive communications from a plurality of different communication channels and configured to filter the communications based on filter criteria to obtain a filtered set of communications for further processing and wherein selecting a communication comprises selecting the communication from the filtered set of communications.

18. The computer system of claim 12 wherein automatically generating a prompt to a generative model comprises:
accessing the user context information from a plurality of dynamically changing user information sources to obtain the user context information.

19. A computer system, comprising:
at least one processor;
a prompting system configured to automatically select a communication, from a plurality of different communications for a user and to automatically generate an artificial intelligence (AI) prompt to a generative AI model based on the selected communication, the AI prompt including user context information imported from a user information source that stores dynamically changing user context information;
a response receiving system configured to receive a response to the AI prompt from the generative AI model, the response being indicative of a mapping between a task identified in the selected communication and a set of function triggers that trigger functions to execute to perform the task identified in the selected communication, the prompting system being configured to automatically generate a task execution prompt for a generative AI task execution model, the task execution prompt including the set of function triggers; and
a result processor configured to receive an execution result from the generative AI task execution model, the execution result being indicative of a result of executing the task, and to output the execution result for user interaction.

20. The computer system of claim 19 wherein the prompting system includes a prompt chaining processor configured to generate chained prompts and a chain-of-thought processor configured to generate a chain-of-thought prompt.
